(19) United States
(12) Patent Application Publication
(10) Pub. No.: US 2010/0108824 A1
(43) Pub. Date: May 6, 2010

(54) CABLE MANAGEMENT DEVICE

(75) Inventors: Leonard James Patchett, Western Australia (AU); Scott David Lee, New South Wales (AU)

Correspondence Address: MERCHANT & GOULD PC, P.O. BOX 2903, MINNEAPOLIS, MN, 55402-0903, US

(73) Assignee: ADC GmbH, Berlin (DE)

(21) Appl. No.: 12/522,976

(22) PCT Filed: Dec. 12, 2007
(86) PCT No.: PCT/EP07/10936

§ 371 Date: Dec. 16, 2009

(30) Foreign Application Priority Data
Jan. 18, 2007 (AU) 2007900234

(51) Int. Cl. F16L 3/22

(52) U.S. Cl. 248/68.1

(57) ABSTRACT

The invention relates to a cable organization device (10) with a body (12) formed of resilient material. The body comprises cavities for holding the cables (20). Each cavity (20) comprises a cable holding section (22) for accommodating a cable, and a relatively small input section (24). The cable can be introduced in the respective cavity (20) through the input section in that the input section is opened with resilient deformation by the sections (26) of the cable defining the input section.

### FIELD OF THE INVENTION

This invention relates to a cable management device.

### BACKGROUND OF THE INVENTION

For ease of handling, cables such as telecommunications cables may be tied in a bundle by use of flexible plastic ties having an elongate tongue portion with an eye at one end, through which eye the other end of the tongue portion may be threaded, to form a loop around the cables, cooperating latching formations on the eye and tongue portion engaging to prevent the loop from being released. This generally results in the bundle of cables assuming a round shape when viewed in cross-section. This may be undesirable, for example making it difficult to visually trace the paths of individual cables. Another technique is to lace the cables using fine thread, such as nylon thread. This is however time consuming and may result in damage to the cables due to the thread embedding into the cable. Also, subsequent lengthwise adjusting the position of individual cables is difficult or impossible.

### SUMMARY OF THE INVENTION

In one aspect, the invention provides a cable management device having cable retaining cavities, each cavity having a cable retaining portion for accommodating a respective cable and a relatively narrow entrance portion through which the cable may be inserted into the respective cavity by opening of said entrance portion under resilient deformation of portions of the cable defining the entrance portion.

The cavities may be arranged in a row, with the entrance portions of the cavities disposed at one side of the device.

There may be two rows of the cavities, disposed at opposite sides of the device. The cavities of one said row may be disposed at lengthwise locations along the respective side so that these locations are, reckoned in the directions of extent of the rows, displaced in the lengthwise direction with respect to the locations of adjacent cavities in the other row. The cavities within each said row may be equi-spaced along the row, the spacing between adjacent cavities being the same in each row, and said displacement in the lengthwise direction being by one half the spacing between adjacent cavities.

The portions of the cable management device defining the entrance portion may be parts of tongue-like portions disposed between adjacent cavities.

The cable management device may be formed as a moulded body of resilient plastics material.

The invention also provides a cable assembly having a cable run formed of a plurality of side-by side cables, the cables being retained in a cable management device as above described. There may be a plurality of the devices arranged at spaced locations along the length of the cable run. Preferably cables of said cable run are disposed at correspondingly located ones of the cavities on each device.

The invention also provides a method of running a plurality of cables in which the cables are engaged and retained in the cavities of the cable management device of the invention.

The cables may be engaged and retained in the cavities of the cable management device before said cables are run. The running of said plurality of cables may be performed by pulling the cables while engaged and retained in the cavities of the cable management device.

The mentioned cables may be telecommunications cables.

### BRIEF DESCRIPTION OF THE DRAWINGS

The invention is further described by way of example only with reference to the accompanying drawings in which:

FIG. 1 is a plan view of a cable management device formed in accordance with the invention;

FIG. 2 is a side view of the cable management device of FIG. 1;

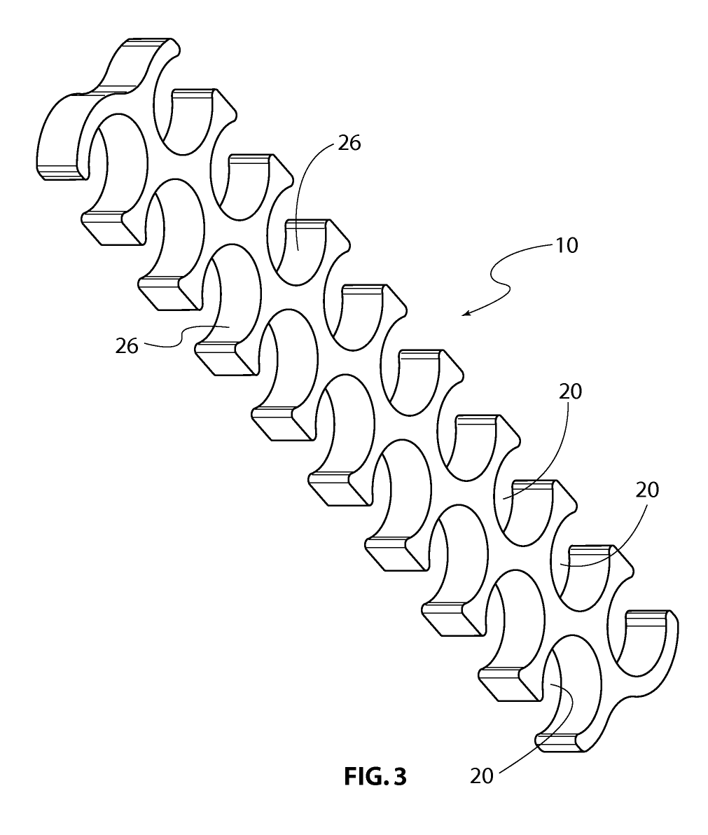

FIGS. 3 and 4 are opposite side perspective views of the cable management device of FIG. 1;

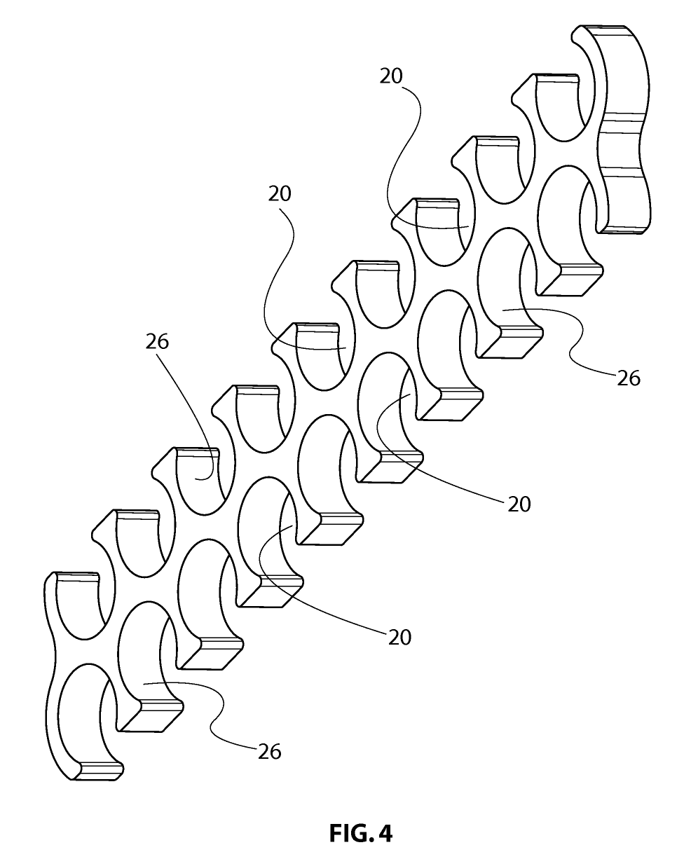

FIGS. 5 to 8 are scrap views illustrating how a cable is inserted into the cable management device of FIG. 1, and

FIG. 9 is a perspective view of a cable assembly incorporating a plurality of devices shown in FIGS. 1 to 4.

### DETAILED DESCRIPTION OF THE PREFERRED EMBODIMENTS

The cable management device 10 shown is in the form of a plastics moulding having a flat elongate generally rectangular body 12. At each of two opposed longer sides, 14, 15, the body 12 has a respective row 16, 18 of cable retaining cavities 20. The cavities 20 have a part circular cable retaining portion 22, and a relatively narrow entrance portion 24 open to the respective side 14 or 15 of the body. The entrance portions 24 are defined between tongue-like portions 26 of body 12. Except for end ones of the portions 26, these are between adjacent ones of the cavities 20 in each row 16, 18. As shown, except for end ones, each portion 16 has an outstanding part 36 and at the outer end thereof, a sidewardly enlarged head part 38. The end tongue-like portions 26a only define curved tongue-like projections.

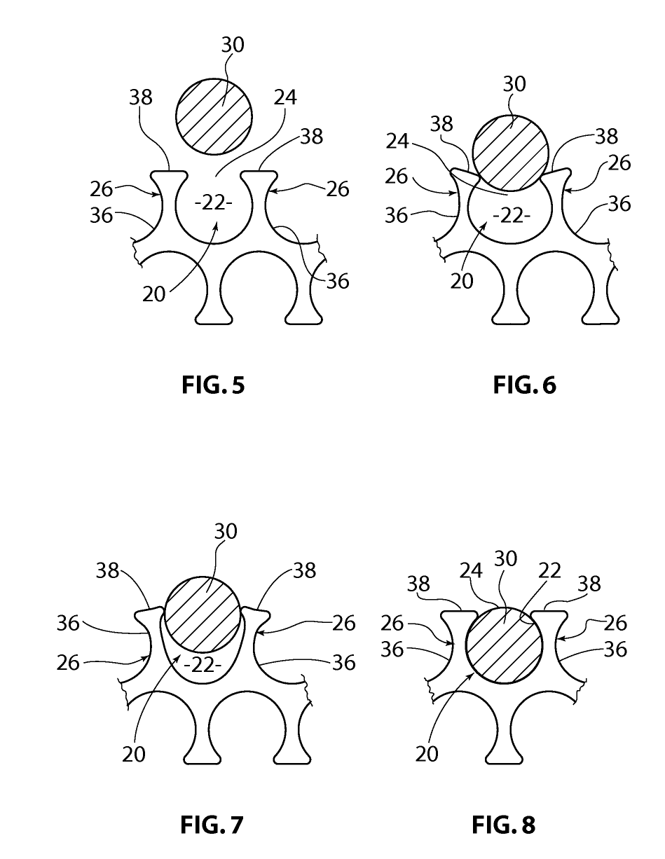

FIGS. 5 to 8 illustrate the manner in which a cable 30 is inserted into a cavity 20 of the device 10. As shown, the cable 30 is advanced to the device 10 so as to approach the entrance portion 24 of the cavity. By continuance of that movement, the cable contacts ends of the tongue-like portions 26 at either side of the entrance portion 24 (FIG. 7) then, by camming action, causing the tongue-like portions 26 to resiliently bend outwardly (FIG. 7) to increase the width of the entrance portion 24 of cavity 20 until the cable passes through entrance portion 24 to enter the cable retaining portion 22 of the cavity. Then, under natural resilience, the tongue-like portions 26 revert to their initial form, to close the entrance portion 22 of the cavity 20, so that the cable 30 is neatly accommodated in the cavity 20, and removal is resisted by the parts 38 of the tongue like portions 26 defining entrance portion of the cavity.

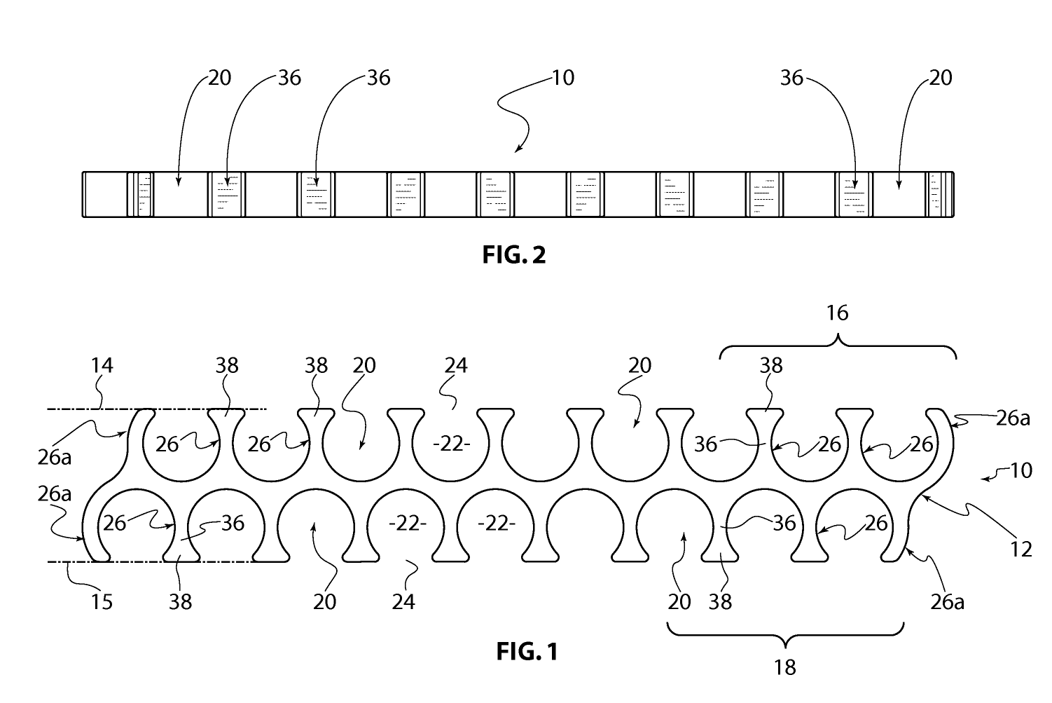

Cables 30 can be removed by sidewardly pulling on the cable to cause the ends of the tongue-like portions 26 to be resiliently outwardly deformed to enable the cable to pass out through the so enlarged entrance portion, after which the portions 26 revert to their rest positions (FIG. 1) under natural resilience.

As shown, the cavities 20 of the row 16, 18 at one side of the device 10 are offset with respect to those in row 18, 16 at the other side, by an amount equal to one half of the pitch distance between cavities in a row. By this, it is possible, as shown, to reduce the side to side distance between the centres of cavities in one row and the centres of the cavities in the other row, so that the side to side dimension of the device 10 is reduced, a more compact arrangement of inserted cable is achieved, and less material is required to form the device 10. Also, this may result in a somewhat more flexible device, which may be desirable in facilitating deformation of the device 10 as a whole, to permit insertion or removal of a cable 30 from a cavity 20 where an adjacent one or ones of the cavities are already occupied by cables.

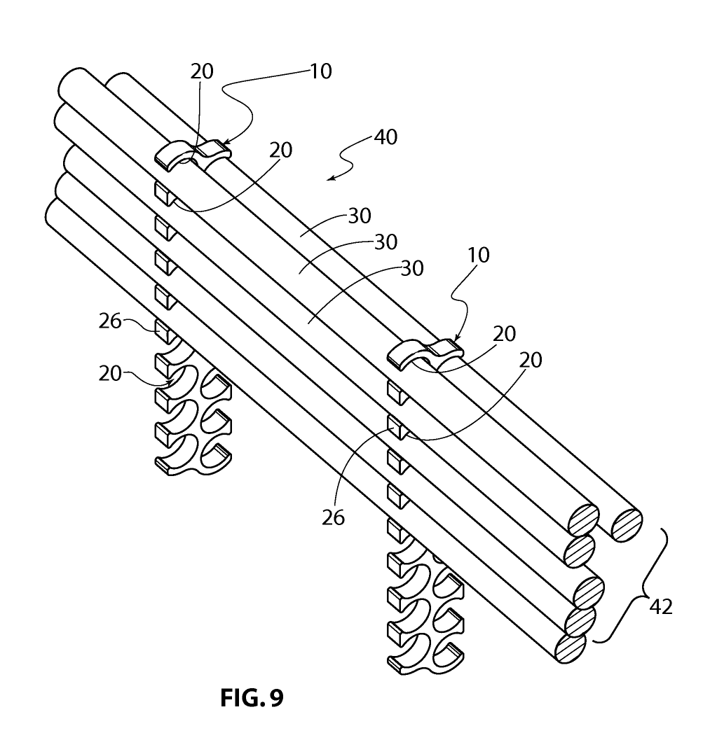

The cable assembly 40 in FIG. 9 has a cable run 42 having a number of cables 30 connected to cable management devices 10 as described above. The devices 10 are arranged at spaced locations along the cable run, and receive cables 30 forming the cable run in respective ones of the cavities 20. Accordingly, the cables are maintained in a neat and orderly physical arrangement. By, for example, ensuring that each cable 30 is received in a respective cavity 30 at the same location on each device 10, it is easy to visually identify individual cables along the length of the cable run, even if the cables carry no specific external identification markings.

In the described arrangement, the cavities are circular, in view of the intended use with the described circular cables. The part-circle representing the periphery of the cable retaining portion 22 of the cavity may represent about a 60-85% segment of a circle. For example, entrance portion 24 may present a gap for cable entrance that is, in the natural configuration of the device 10, about 20% less than the cable diameter. Generally, the diameter of the cable retaining portion 22 may be about 25% more than the diameter of the cable 30. Of course, the shape and size of the cavities may be adapted in accordance with the shape and size of the cables 30 with which the device is to be used.

The device may be made from any suitable material, particularly material having suitable natural resilience. It has been found that flexible polycarbonate material is suitable.

Use of devices 10 has been found to greatly facilitate laying cable. By providing devices 10 at spaced locations along the length of a cable run, the cables can for example be readily pulled through cavities. This is particularly so where pulling the cables around bends is necessary.

The described construction has been advanced merely by way of example and many modifications and variations may be made without departing from the spirit and scope of the invention, which includes every novel feature and combination of features herein disclosed.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that that prior publication (or information derived from it) or known matter forms part of the common general knowledge.

### LIST OF PARTS

10 cable management device

12 body

14, 15 sides

30 cable

16, 18 rows

20 cavities

22 cable retaining portion

24 entrance portion

26 tongue-like portion

36 outstanding part

38 head part

40 cable assembly

42 cable run

1. A cable management device (10) having cable retaining cavities (20), each cavity having a cable retaining portion (22) for accommodating a respective cable (30) and a relatively narrow entrance portion (26) through which the cable (30) may be inserted into the respective cavity (20) by opening of said entrance portion (26) under resilient deformation of parts (38) of the cable retaining device defining the entrance portion.

2. A cable management device as claimed in claim 1 wherein the cavities (20) are arranged in a row (16, 18), with the entrance portions (26) of the cavities (20) disposed at one side of the device (14, 15).

3. A cable management device as claimed in claim 2 wherein there are two rows (16, 18) of the cavities (20), disposed at opposite sides (14, 15) of the device (10).

4. A cable management device as claimed in claim 3 wherein said cavities (20) of one said row (16, 18) are disposed at lengthwise locations along the respective side (14, 15) so that these locations are, reckoned in the directions of extent of the rows (16, 18), displaced in the lengthwise direction with respect to the locations of adjacent cavities (20) in the other row (16, 18).

5. A cable management device as claimed in claim 4 wherein the cavities (20) within each said row (16, 18) are equi-spaced along the row, the spacing between adjacent cavities (20) being the same in each row, and said displacement in the lengthwise direction is by one half the spacing between adjacent cavities (20).

6. A cable management device as claimed in any preceding claim wherein said parts of the cable management device defining the entrance portions are parts (38) of tongue-like portions (26) disposed between adjacent cavities.

7. A cable management device as claimed in any preceding claim formed as a moulded body (12) of resilient plastics material.

8. A cable assembly (40) having a cable run (42) formed of a plurality of side-by side cables (30), the cables being retained in a cable management device (10) as claimed in any one of claims 1 to 6.

9. A cable assembly as claimed in claim 7 wherein there are a plurality of the devices (10) arranged at spaced locations along the length of the cable run (42).

10. A cable assembly as claimed in claim 8 wherein said cables (30) are positioned in correspondingly located ones of the cavities (20) on each device (10).

11. A cable assembly as claimed in any one of claims 8 to 10 wherein said cables (30) are telecommunications cables.

12. A method of running a plurality of cables (30) in which the cables are engaged and retained in the cavities (20) of a cable management device (10) as claimed in any one of claims 8 to 10.

13. A method as claimed in claim 12 wherein said cables (30) are engaged and retained in the cavities (20) of said cable management device (10) before said cables are run.
